(19) United States
(12) Patent Application Publication
(10) Pub. No.: US 2025/0046208 A1
(43) Pub. Date: Feb. 6, 2025

(54) SIMULATION CHAMBER FOR SIMULATING ENVIRONMENTAL AND AMBIENT CONDITIONS

(71) Applicant: HOCHSCHULE KARLSRUHE, Karlsruhe (DE)

(72) Inventor: Bernhard LENZ, Gernsbach (DE)

(73) Assignee: HOCHSCHULE KARLSRUHE, Karlsruhe (DE)

(21) Appl. No.: 18/714,607

(22) PCT Filed: Nov. 30, 2022
(86) PCT No.: PCT/EP2022/083852

§ 371 Date: Aug. 27, 2024

(30) Foreign Application Priority Data
Dec. 1, 2021 (DE) 10 2021 131 535.2

(51) Int. Cl. G09B 9/00; A63F 13/28; G09B 5/02

(52) U.S. Cl. CPC G09B 9/00; A63F 13/28; G09B 5/02

(57) ABSTRACT

A simulation chamber (1) for use by a user (6) with a virtual reality device (5) for visually simulating environmental and ambient conditions includes a chamber (3) surrounding an interior space (2) and a flow-generating apparatus arranged on the chamber (3) for generating an air flow (13) in the interior space (2). The simulation chamber (1) includes a headwind flow-generating apparatus having at least one outflow opening (12), which is arranged in the chamber (3) so as to be movable by means of a movement apparatus. The at least one outflow opening (12) can be moved by the movement apparatus such that a headwind flow (11) can be directed, through the at least one outflow opening (12), onto the user (6) located in the interior space (2) during intended use from a consistently predefinable headwind flow direction relative to an orientation of the user (6).

### CROSS-REFERENCE TO RELATED APPLICATION

This application is a national stage application, filed under 35 U.S.C. § 371, of International Patent Application PCT/EP2022/083852, filed on Nov. 30, 2022, which claims the benefit of German Patent Application DE 10 2021 131 535.2, filed on Dec. 1, 2021.

### TECHNICAL FIELD

The disclosure relates to a simulation chamber for use by a user with a virtual reality device for visually simulating environmental and ambient conditions, the simulation chamber comprising a chamber surrounding an interior space and a flow-generating apparatus arranged on the chamber for generating an air flow in the interior space.

### BACKGROUND

The term “virtual reality” is understood to mean the display and perception of an apparent reality in an interactive environment generated by a computer. This is intended to allow a user to immerse themselves as deeply as possible in a simulated virtual environment, with their own actions having an effect on this virtual environment and their perception and being able to influence and modify the virtual environment as realistically as possible. The possible fields of application of virtual reality range from computer games in which entire game worlds can be simulated, to psychotherapy and the wellness sector, through to realistically simulated exercises, possibly as part of vocational training. Using virtual reality, complex facts or scientific information can also be displayed in a graphic and comprehensible manner and can be made tangible to a user. For example, information about the future effects of climate change or individual urban development projects as well as research results from the fields of chemistry, medicine and other sciences can be displayed to a user in a comprehensible manner.

Commonplace, simple virtual reality systems are mainly based on visual and acoustic stimulation of the user. Simple virtual reality devices that are cost-effective to purchase, such as headphones or glasses, which visually present a simulated environment to the user by means of displays, are used for this purpose. This one-dimensional or two-dimensional approach can be perceived as limiting and restrictive, however, since not all of the person's senses are addressed, which can hinder the complete immersive experience, or the user is aware that the simulated environment is a simulation and does not perceive it as the apparent reality.

In order to get around these limitations and for the simulated environment and its realistic situation to be able to be perceived as realistically as possible, simulation chambers are therefore also known from the prior art in which a user with a virtual reality device of this kind can not only perceive a visual display of a simulated environment, but they can also be stimulated by other sensory perceptions. These simulation chambers are configured such that they partially or even completely surround a user, in order to be able to also stimulate other senses, such as perception through the skin or the feeling of temperature, in addition to visual and acoustic stimulations. Furthermore, completely closed systems provide the option of being able to better control or block off undesired external stimuli for the user. During the simulation, the user is in a chamber of the simulation chamber which blocks the user off from their surroundings, and they can be visually and acoustically stimulated by the virtual reality device. In addition, suitable devices can be used to generate other sensations, such as effects of a user's movement within the simulated environment, an ambient temperature or air flows, which have an additional effect on the user, thus providing the most realistic possible perception of the simulated environment or display.

In this case, depending on the configuration of the simulation chamber, the user has two options for movement. The first option is an actual movement of the user within the chamber, with a movement actually made by the user being detected and taken into account in the display of the virtual world, and the second is an entirely virtual movement, such that the user remains largely unmoving in one position in the chamber and only the effects of a simulated movement are transmitted to the user, or actions can be taken on the user by suitable devices, such as a pivotable and vibrating seat. Furthermore, there is the option of a mixture of both variants of an actual movement and a virtually suggested movement.

While ambient conditions such as an ambient temperature or wind or weather conditions can be realistically simulated within a chamber using suitable devices, the simulation of a perception of a headwind, generated by a rapid movement of the user, is comparatively complex and often does not allow for a realistic perception by the user during an actual movement of the user in the chamber. In a forward movement, a headwind is routinely perceived, which is directed counter to the movement direction of the user. Here, the headwind corresponds in speed to the movement speed of the user. This movement by the user can correspond to walking or running, during which a noticeable headwind is usually perceptible. The movement by the user can also be simulated and assisted by auxiliary means, such that the user is moving on a skateboard, a bicycle or any vehicle as part of the simulation, for example, and expects a corresponding airstream as the headwind while travelling along. A headwind of this kind can be generated by corresponding flow-generating apparatuses on a stationary user who is not moving much within the simulation chamber and can be directed onto the user, with their position and orientation within the chamber being predefined or known. For example, headwind flow-generating apparatuses in the form of fans that are installed in the chamber and are optionally arranged to be distributed over the chamber at a distance from one another are known from the prior art for generating a headwind.

If, however, the user is moving around freely in the chamber and is supposed to be able to turn around, for example, this necessarily results in a change in the position and orientation of the user within the chamber. In this case, there are frequently movement situations in which the user is not in an orientation suitable for the simulation of a headwind or airstream relative to the fans of the headwind flow-generating apparatus and the headwind is therefore not perceived as realistic.

It is very important here to accurately determine the position of the user in the chamber for the realistic simulation of the ambient conditions, since only by identifying the position or orientation of the user in the space can the virtual movement be realistically simulated by the orientation of the headwind. For a simulated movement of the user in the virtual space at a consistent speed, the headwind which is flowing onto the user and is generated by the fans would have to follow the relevant orientation of the user within the chamber and therefore be subject to an ongoing change in direction and, as a consequence, a change in intensity for the individual fans. The headwind perceived by the user should, however, be perceived as consistently as possible for a realistic simulation. Currently known arrangements comprising fans on a plurality of or all side walls of the chamber routinely require complex control, which is likewise elaborate and costly, not just because of the air flows generated by the individual fans needing to be overlaid. It has been found that overlaying individual air flows often results in turbulence or flow conditions that are no longer perceived as realistic and therefore are not perceived as realistic overlaying of ambient conditions with a headwind caused by the user. In particular, a fast movement by the user within the simulated environment can no longer be appropriately simulated due to the headwind acting on the user, which should be perceived much more strongly than other air flows in the environment.

### SUMMARY

A problem addressed by the present disclosure is therefore considered that of providing a simulation chamber by means of which a headwind can be realistically simulated in a predefined simulated environment as simply and reliably as possible and can act on a user who is in the chamber.

This problem is solved in that the simulation chamber comprises a headwind flow-generating apparatus having at least one outflow opening, which is arranged in the chamber so as to be movable by means of a movement apparatus, the at least one outflow opening being able to be moved by means of the movement apparatus such that a headwind flow can be directed, through the at least one outflow opening, onto a user located in the interior space during intended use such that the headwind flow flows against the user from a consistently predefinable headwind flow direction relative to an orientation of the user.

This configuration of the simulation chamber allows for a realistic simulation of headwind even when the user turns around and thus changes their orientation within the chamber. By means of the movement apparatus, the outflow opening can be guided to follow the user's movements in all movement situations in real time such that the headwind flow is always directed onto the user from a predefined direction in order to allow for a simulation of the headwind that is perceived as realistic. The simulation of ambient wind or weather conditions prevailing in the environment, as can be simulated by an air flow from a flow-generating apparatus conducted through the interior space, for example, is separate and isolated from the simulation of the headwind. The headwind or the headwind flow simulating the headwind can be generated by the headwind flow-generating apparatus here. The headwind flow-generating apparatus can be arranged on the movement apparatus or in or on the chamber, the generated air flow being able to be passed on by being suitably passed on to the at least one outflow opening arranged on the movement apparatus and being able to be directed onto the user along a headwind flow path.

The movement apparatus can, for example, be implemented as a rail system that is arranged on one side wall of the chamber and covers that side wall, and comprises a rail and a slide. In this case, the outflow opening can be fixed to the slide of the rail system arranged on the rail, the slide comprising the outflow opening being movable along the rail. Furthermore, the rail can be arranged annularly on the side wall, such that the outflow opening can be guided to follow the user reliably and rapidly in all directions when they turn around or change their orientation. Furthermore, other configurations or arrangements of the rail system or the movement apparatus are also conceivable which make it possible for the outflow opening to be arranged to be movable on the chamber, and this allows the headwind flow to be directed onto the user, whatever orientation and movement situation they are in.

The virtual reality device can be configured as headphones with a display, a simulated environment being visually presented to the user by means of the display. Instead of headphones equipped with a display, a display can also be installed at the user's eye level, which preferably covers the user's entire field of view and thus determines the visual stimuli coming towards them. In an alternative configuration, the side walls can comprise one or more displays, which can partially or even almost completely cover the side walls, with the exception of chamber openings for introducing air flows. Therefore, it is possible for the user to be immersed in a simulated world without feeling that their experience is being restricted or dampened by the headphones they are wearing on their head and without the display installed in front of them disappearing from their field of view when they move. Therefore, the user can experience almost complete immersion in the simulated environment, such that their consciousness can be pushed so far into the background that the virtually created simulation is perceived as the real world.

The simulation chamber can therefore be used for various applications. For example, it can also be used for the simulation of future urban development projects, in order to simulate their effects on the sensory perceptions of persons who are standing close to or in planned buildings. In this way, the way in which future structures will affect the environment and how they will be perceived by persons in the environment can be realistically perceived and assessed. For instance, air flows and shadows caused by a structure in adjacent regions on streets and open spaces can be generated, for example. Furthermore, a different façade design can often not only have a great impact on the visual perception, but also on the temperature and wind conditions felt when the user is moving around the structure. As a result, before implementing structural measures, the situation that would actually later exist can be put across.

However, the simulation chamber is not limited to this type of application, but rather it can be used to carry out various simulations, in particular those which benefit from the simulation of the most realistic possible environmental and ambient conditions. This also includes, inter alia, the simulation of future consequences of climate change or other future events or situations. Another important field of application can be its use in the computer-game and console-game sector, which allows for a particularly realistic simulation that addresses all the player's senses.

It is optionally provided that the movement apparatus is a platform which is mounted so as to be rotatable about a vertical axis on the floor of the interior space of the chamber and on which the user fitted with the virtual reality device is located during the intended use, and that the outflow opening is arranged on the platform. The headwind flow-generating apparatus or at least the outflow opening is advantageously fixed to the rotatably mounted platform and is therefore arranged in a substantially consistent position and orientation relative to the user. When the platform rotates about the vertical axis, which simulates the orientation of the user changing within the simulated environment, the headwind flow-generating apparatus or the outflow opening rotates with it, such that the relative arrangement at least of the one outflow opening to the user standing on the platform during the intended use remains constant. This arrangement on the platform can therefore mean that the simulated headwind is always head on and therefore can be directed onto the user counter to the movement direction directed forwards from the user.

The rotatably mounted platform can respond to actions performed by the user within the simulated environment. The rotatably mounted platform can also respond to the user's body movements or to them shifting their weight and can be rotated accordingly in order to thus achieve an actual rotation. The platform can be configured such that a rotation about 360° or more can be produced, meaning that the user's possible movements are not restricted and the most realistic possible range of motion can be achieved. Forward movements by the user can take place purely virtually in this case. When driving around a corner, for example, there is an actual rotational movement in combination with a purely virtual forward movement, but other kinds of non-linear movement are also possible. In order to achieve the greatest possible degree of freedom for simulated movements and also to be able to realistically simulate changes in height during a sequence of movements, it can also be provided that the platform is not only rotatably mounted, but is also mounted to be pivotable or movable as a whole in all directions relative to a horizontal orientation. In this way, driving up and down hills or movement over uneven ground can also be realistically simulated. Through all of this, the user remains almost stationary on the platform and only makes relatively small movements thereon.

According to an advantageous configuration, it is provided that the platform comprises a holding device such that a user standing on the platform can hold on to the holding device with at least one hand. The holding device can make their time on the platform easier. During the movements of the platform, the holding device can assist the user in safely standing thereon during the simulation. Many users find the option of holding on during the simulated perception of an environment to be welcome. In addition to its purely assistive and holding function, the holding device is also used to predefine the position of the user during the simulation, in order to create a pleasant simulation that is as realistic as possible by means of the targeted simulation and adjustment of the ambient conditions and by air flows that are directed in a targeted manner.

Furthermore, the holding device can be configured as an input or interaction apparatus and can be used by a response being able to be triggered in the virtual environment by targeted manipulation of the holding device or an actuating element arranged thereon, for example. For example, the holding device can be configured as a cylindrical bar which is fixed to the platform, projects into the space and optionally comprises a standing surface for connecting the holding device to the platform, the holding device being able to comprise an additional handle for a secure and ergonomic grip. By the user shifting their weight and/or by the holding device tilting or moving, a rotation or movement of the platform can be initiated, for example, which again brings about a simulated rotation within the virtual simulation. Furthermore, switches, buttons or handles can be provided on the holding device for the purposes of manipulation which can trigger both a movement or action in the actual environment and a corresponding change and simulation in the virtual environment. The holding device expediently has the smallest possible volume and low flow resistance, in order to have as little influence as possible on the ambient conditions simulated in the chamber.

According to an advantageous implementation, it is provided that the at least one outflow opening is arranged on the holding device. The headwind flow-generating apparatus can have one or more fans, which can direct the headwind flow through the at least one outflow opening onto the user's hands and/or facial area in order to generate headwind during a virtual movement. Depending on the complexity and the requirements placed on the headwind flow, the headwind flow can be directed onto these areas, or can also completely surround the user, for example. Advantageously, the fans or other devices for generating a headwind flow can be arranged at a separate location from the holding device. The headwind flow generated therein can be supplied to the holding device through narrow lines or flow ducts and can flow out through nozzles arranged on the holding device and can be directed onto the user. The holding device can comprise one or more nozzles, which are arranged at a distance from one another and form the outflow opening, on a side of the holding device facing the user for this purpose. The nozzles can, for example, discharge a constant headwind flow flowing against the user from the front at a simulated constant movement speed. In this process, the intensity of the headwind flow can be accordingly adjusted when the speed changes. This provides the advantage that there does not need to be any rotating fans or otherwise moving parts within the chamber and in the immediate surroundings of the user, which could lead to the user being impeded or even injured during a simulation and would also influence and disrupt the ambient conditions simulated in the chamber in an uncontrolled manner.

It is preferably provided that the simulation chamber comprises a positioning apparatus arranged in the chamber, which is configured to support the user in the chamber in order to facilitate movements on the spot. The positioning apparatus can be arranged in the chamber, and this allows the user to be supported by the positioning apparatus during the simulation. In a possible configuration, the positioning apparatus can be arranged on a ceiling of the chamber and can be configured as a rotatable ring, for example. The user can be connected to the ring by a connecting apparatus that can connect the ring to the user, such as ropes, chains or straps. For this purpose, the user can wear a belt, a vest or a harness that encompasses the upper or lower body, the connecting apparatus being fixed to the belt, the vest or the harness. By the ropes, the chains or the straps having a resilient configuration, the user can be supported, while being able to place their feet on the ground. This allows the user to move or run on the spot, while the user still has the freedom to turn around while being supported by the positioning apparatus. In an alternative configuration, the user can “hang from the ropes”, so to speak, meaning that their feet are no longer in contact with the ground. This again allows the user to have all the degrees of freedom available to them, meaning that they are not restricted in their movements.

Furthermore, the outflow opening and/or the headwind flow-generating apparatus can be arranged on the positioning apparatus. For example, the headwind flow-generating apparatus can be arranged on the rotatable ring, and the generated headwind flow can be directed onto the user via a flow duct. A configuration of this kind allows the user turning around to be transferred to the ring, with the outflow opening likewise being able to follow the user turning around owing to it being rigidly fixed to the ring.

Furthermore, it is possible and optionally provided that the positioning apparatus and/or the movement apparatus comprises a first arm segment and at least one second arm segment arranged thereon, the first arm segment and the at least one second arm segment being movable relative to one another. In addition to a configuration of the positioning apparatus with ropes, chains or straps supporting the user, the positioning apparatus can be configured as a robot arm. This robot arm, which is arranged on a side wall, the floor or the ceiling and is equipped with a plurality of segments arranged to be movable relative to one another, can support the user during the simulation in the same way as the above-described ropes, chains or straps, and it is preferably configured such that it supports the user but in no way restricts their movement, in order to thus allow for the most realistic possible simulation. To do this, it can be fixed to a belt, vest or harness worn by the user. While wearing this, the user is preferably also able to jump, duck or lay down.

In addition to a purely supportive configuration, with the user being active and the robot arm following the user's movements, the robot arm can also be configured such that the user is supported on the arm, but remains thereon in a merely passive manner, and the robot arm specifies the user's movements on the basis of the simulation being carried out.

In addition to these configurations, the movement apparatus bearing the outflow opening can likewise be configured as an above-described robot arm. By means of this configuration, the following guidance of the outflow opening can be particularly efficiently adjusted to the user's movements.

In an advantageous configuration, it is provided that the simulation chamber comprises a position detection apparatus, the position and orientation of the user being detected by means of the position detection apparatus and the at least one outflow opening being guided to follow the user such that the headwind flow is always directed onto the user from a predefined direction. In order to simulate a realistic headwind, one requirement is that the headwind flow directed onto the user by the at least one outflow opening is always directed onto the user head on from a predefined direction. In particular in a configuration of the simulation chamber in which the user can move around freely in the chamber, it is necessary that the current position of the user is identified in real time, in order to be capable of adjusting the headwind flow to the user's movements and guiding it to follow these movements.

In this case, the position detection apparatus is configured as a camera arranged in the chamber, which can determine the user's position in the chamber by optically detecting them. For example, the user's face and thus their relative orientation in the chamber can be determined in the images captured by the camera using facial recognition software. Furthermore, the evaluation can also be carried out by identifying the user themselves or by way of distinctive features of the human body, such as the head and the extremities. By suitably relaying and processing the optical data captured by the camera, the movably arranged outflow opening can be subsequently moved such that the headwind flow expelled by the outflow opening always strikes the user in a predefined orientation with the correct intensity.

Advantageously, it is optionally provided that the platform comprises a treadmill, such that the treadmill can be used to simulate the user running. The treadmill can be configured and configured such that the user running on the treadmill is converted into a running movement of the user in the simulated environment.

Advantageously, the treadmill is an omnidirectional treadmill, which allows for not only forward and backward movements, but also movements to the side and diagonal movements. This provides the most realistic possible, intuitive control or movement in the virtual environment. In this case, the treadmill can be arranged on the platform such that the user is standing on the treadmill during the intended use. While standing and moving on the treadmill, the user can hold on to the holding device while running. Furthermore, the treadmill can be implemented in the form of a rotatably mounted and optionally driven ball, on which the user stands during the simulation. For this purpose, the ball can be arranged in a cut-out in the floor, such that only the top of the ball protrudes out of the cut-out into the interior space of the chamber. In this scenario, the user stands on the ball during the simulation, and this ball allows for a running movement in all directions, in the same way as the omnidirectional treadmill.

Optionally, the simulation chamber can comprise the positioning apparatus in addition to the treadmill, in order to protect the user against falling and injury.

According to an advantageous configuration, it is provided that the platform comprises a seat. A seat on which the user can sit during a simulation provides the advantage over a standing user that any balance problems that the user has, in particular during the first use, can be avoided or at least reduced, and therefore injury can be prevented, in the same way as when the positioning apparatus is used. Furthermore, a seat provides the option of installing various interaction and manipulation devices in order to provide convenient control and interaction of the real world with the virtual world. Furthermore, the use of a seat creates a realistic experience, for example in a driving simulation or in other simulations in which the user also sits down in the virtual world. The seat can be securely connected to the platform, such that the seat also rotates when the platform rotates. Furthermore, a seat provides the option of providing the user with more stimuli, by the seat being cooled, heated, or its position being changed, in order to simulate the seat shaking, for example. The holding device can be configured as part of the seat or can be arranged on the platform independently of the seat.

It is also possible and optionally provided that the headwind flow-generating apparatus or at least the outflow opening is arranged on the seat. Alternatively or additionally to the arrangement of the headwind flow-generating apparatus on the platform or on the holding device, the headwind flow-generating apparatus can also be arranged on the seat when the simulation chamber is configured to have a seat.

It is preferably provided that the holding device and/or the treadmill and/or the seat are arranged to be pivotable at an angle to the vertical axis. In addition to rotation of the platform, for example caused by a body movement which is transferred to the platform via the holding device connected to the platform and/or the treadmill and/or the seat, it may be advantageous to simulate movement sequences by the entire platform or only the holding device and/or treadmill and/or seat being pivotable at an angle to the vertical axis. This allows for a realistic driving simulation, for example when cornering, by the user being able to “lean into the corner”. For this purpose, the holding device and/or the treadmill and/or the seat can be connected to the platform by a suitable device which advantageously allows for an inclination in all spatial directions. Therefore, a rotation in the horizontal plane can be produced by a rotation of the platform and additionally an inclination of the user can be produced by the holding device and/or the treadmill and/or the seat. Furthermore, a variant is of course conceivable in which the platform also allows for an inclination in addition to the rotation and the holding device and/or the treadmill and/or the seat are connected to the platform rigidly or at least for conjoint rotation.

Furthermore, in addition to the option of a simulated movement in the virtual environment being performed by an actual movement by the user on the platform, in a simulated movement through a virtual world that is predefined by the simulation, the actual movement within the chamber is not triggered by the user, but instead the platform and/or the holding device and/or the treadmill and/or the seat are moved in line with a movement sequence predefined by the simulation, meaning that a realistic perception of the simulated movement can be achieved.

Furthermore, it is possible and optionally provided that the flow-generating apparatus is configured to simulate ambient wind in the interior space of the chamber by means of the generated air flow. If wind is intended to be simulated from a predefined direction and at a predefined intensity, the flow-generating apparatus arranged on the simulation chamber can be actuated in order to generate an air flow within the chamber. In an arrangement outside the simulation chamber, the generated air flow can be conducted into the interior space of the chamber through ducts that are suitable for this purpose. Here, the air flow can be directed onto the current position of the user in order to give the user the sensation of wind. For a realistic simulation, the flow-generating apparatus can for example have a plurality of fans, which are arranged and moved within the interior space or of which the orientation can be changed. It is also possible for a plurality of fans to be arranged to surround the interior space and for the thus generated air flows to be introduced into the interior space of the chamber through openings or nozzles. In this case, depending on their arrangement, the openings or nozzles in question can be actuated such that the desired flow conditions are produced within the chamber. It is also conceivable such that only those fans or rotors are operated by which an air flow is generated and from the direction of which this air flow is intended to be introduced into the chamber, in order to set the air in motion and conduct it towards the user.

According to an advantageous configuration, it is provided that the simulation chamber comprises an air-conditioning unit for regulating the temperature and/or the humidity in the interior space. The air within the chamber can be conditioned in a predefined manner appropriate for the simulation by means of the air-conditioning unit. In this case, the properties of the air, such as its temperature and humidity, can preferably be predefined very quickly and in real time as far as possible, in order to increase the visual and acoustic stimuli present during the simulation owing to the sensation of temperature and to enhance further facets. The temperature of the air in the interior space can be controlled using a heatable or coolable and thus thermally conditionable chamber, with heat being able to be transferred from a heating apparatus into the interior space of the chamber by convection, for example. Preferably, the cooling apparatus is configured such that the interior space of the chamber can comprise a plurality of regions each having a different temperature and/or humidity.

According to an advantageous implementation, it is provided that the air-conditioning unit is configured to introduce air conditioned by means of a generated air-conditioning flow into the interior space. For this purpose, air conditioned by the air-conditioning unit, i.e. adjusted in terms of its temperature and its water content, can be introduced into the interior space of the chamber at a suitable point and can be conducted out of the chamber again at a given point. In general, it can be assumed that overlaying the air-conditioning flow for conditioning the air in the space by means of the air-conditioning unit and overlaying the air flow from the flow-generating apparatus for generating wind only rarely results in the user's perception being impaired, since the air temperature often changes only relatively slowly, unlike the wind. The air-conditioning flow from the air-conditioning unit is, however, preferably predefined to be spatially separate from the air flow from the flow-generating apparatus as far as possible, in order for it to be possible to prevent the two flows from influencing each other to the greatest possible extent.

A closed circuit for the air-conditioning flow is considered to be advantageous, with the air-conditioning flow only being able to interact with other flows within the chamber. The air-conditioning flow from the air-conditioning unit has only a low flow speed in comparison with the air flow from the flow-generating apparatus, for the purposes of low interaction and turbulence. Any air turbulence that does arise and any turbulent flows generated as a result could impair the user's experience due to noticeable deviations from the simulated environment.

Advantageously, it is optionally provided that the chamber is configured to be double-walled, with a surface delimiting the interior space and a surface delimiting the exterior space that is arranged at a distance from the surface delimiting the interior space, the surface delimiting the interior space comprising openable through-flow openings for admitting air into or letting it out of the interior space. Owing to the double-walled configuration of the chamber walls, a largely laminar flow directed into the interior space of the chamber can be obtained. To generate an air flow having a predefined direction and intensity, the assigned fans on the chamber are operated from the direction of which the wind is intended to come, in order to set the air in motion in this direction through the assigned through-flow openings. By means of suitable further through-flow openings, the air flow can optionally be drawn out of the interior space into the intermediate space so as to be assisted by the suction of a further fan, which is arranged to be opposite relative to the interior space and is suitably operated. By the chamber being double-walled, the inner wall and the outer wall each interact in the manner of a vertical air duct in the region of the side walls and in the manner of a horizontal air duct in the region of the floor and the ceiling. This makes it easier to guide the flow around the interior space of the chamber such that the desired air flow can also be generated centrally or at a plurality of points distributed around the interior space, can be supplied to the respectively desired openings or nozzles via the vertical or horizontal air ducts, and can be introduced into the interior space in a suitable manner with an appropriate orientation. In addition to a configuration having just two or fewer through-flow openings, configurations having a large number of adjacently arranged through-flow openings are also conceivable. Furthermore, the double wall can also comprise a plurality of vertically or horizontally extending ducts that are separate from one another, in order to facilitate yet more precise control and guidance of the air flows. In this case, it can also be provided that the circuit of the air-conditioning unit and the circuit of the air-flow-generating apparatus are isolated by using ducts that extend separately from one another.

As an alternative to one or more fans arranged in the chamber, with the assigned fans arranged on the chamber being operated to generate an air flow in a predefined direction, a central fan can be arranged on the chamber. This central fan can, for example, be arranged in or under the floor, and, via suitable air ducts, the air flow can be introduced into the interior space of the chamber through these air ducts and ultimately through the through-flow openings. As an alternative to this, a further central fan can be arranged in the ceiling opposite the floor, which fan likewise conducts the air flow out of the interior space again via suitable air ducts and thus allows for a laminar flow in the interior space.

It is also possible and optionally provided that the flow-generating apparatus and/or the air-conditioning unit are arranged in an intermediate space between the surface delimiting the interior space and the surface delimiting the exterior space. In addition to the option of arranging the flow-generating apparatus and/or the air-conditioning unit outside or inside the chamber, they can also be arranged inside the intermediate space between the surface of the chamber delimiting the interior space and the surface of the chamber delimiting the exterior space. This not only allows for an outwardly compact design of the simulation chamber, but also, in particular in the configuration of the flow-generating apparatus as fans and rotors, provides a closed system and largely isolates it from external influences and, in so doing, in particular from external pressure changes or temperature fluctuations.

It is preferably provided that the through-flow openings are configured such that conditioned air from the air-conditioning unit and/or the air flow from the flow-generating apparatus can be conducted into the interior space and/or out of the interior space. The through-flow openings that are arranged on the surface delimiting the interior space and penetrate the surface delimiting the interior space can be configured such that they are connected to the flow-generating apparatus and the air-conditioning unit and they can be used, depending on the requirements, to introduce the air flow from the flow-generating apparatus or the flow from the air-conditioning unit into the interior space. This allows the through-flow openings arranged on the surface delimiting the interior space to be used flexibly and provides the maximum amount of freedom compared with being explicitly assigned.

In this case, the through-flow openings can arranged to be distributed over the surface delimiting the interior space in an irregular manner or in a regular pattern. For example, a plurality of rows, which are arranged above one another in a vertical direction, of through-flow openings arranged beside one another in a horizontal direction are arranged on the surface delimiting the interior space, with it also being possible for one row to be assigned to the air-conditioning unit and the following row to be assigned to the flow-generating apparatus.

Furthermore, it is possible and optionally provided that the air conditioned by the air-conditioning unit is conducted into the interior space through at least one air-conditioning opening arranged on the floor and is conducted out of the interior space through at least one air-conditioning opening on the ceiling opposite the floor. The air in the interior space is conditioned via the air-conditioning openings. In this case, an air-conditioning opening arranged on the floor can be used to introduce conditioned air. For this purpose, the floor can for example be configured as a perforated plate or as a plate comprising continuous or intermittent slots. Preferably, in this case, at least one air-conditioning opening is arranged in an edge region of the floor close to the side walls such that the incoming air is conducted past the user of the simulation apparatus in a vertical direction towards the ceiling in order to not be conducted directly onto the user and to be perceived as wind by the user. The air can then be conducted out of the interior space again via the at least one air-conditioning opening arranged on the ceiling. The air-conditioning openings arranged on the floor and the ceiling can be combined with the air-conditioning unit to form a closed interconnected system, with the desired conditioned air for the interior space being provided via the air-conditioning unit.

According to an advantageous configuration, it is provided that the air flow generated by the flow-generating apparatus is a laminar flow, which is conducted into the interior space through at least one wind opening arranged on a side wall of the chamber and is conducted out of the interior space through at least one wind opening arranged on an opposite side wall. The air flow from the flow-generating apparatus can be introduced into the interior space via the at least one wind opening arranged on the side wall of the chamber. By means of an assigned wind opening on the outlet side opposite the inlet side, a laminar and horizontally guided air flow can be achieved, which is ideally used to simulate wind. The air flow in the intermediate space between the surface delimiting the interior space and the surface delimiting the exterior space can then be conducted away and supplied to the flow circuit again. Alternatively, the air flow from the wind openings arranged on the surface delimiting the interior space can be conducted away via ducts and supplied to the flow circuit again.

In this case, the wind openings can arranged to be distributed over the surface delimiting the interior space in an irregular manner or in a regular pattern. For example, a plurality of rows, which are arranged above one another in a vertical direction, of wind openings arranged beside one another in a horizontal direction are arranged on the surface delimiting the interior space.

According to an advantageous implementation, it is provided that the air-conditioning openings in the floor or close to the floor and the wind openings in the side walls are arranged to be laterally offset, such that turbulence of the air flow and the air-conditioning flow can be reduced. In order to avoid the respective flows from being overlaid and influenced in an undesired manner, the air-conditioning openings and the wind openings can be arranged to be spatially offset from one another such that the respective flows are guided through the interior space of the chamber independently of one another and are not significantly overlaid and disrupted.

Advantageously, it is optionally provided that the simulation chamber comprises a solar simulation apparatus for simulating solar radiation. In order to facilitate the most realistic possible virtual reality experience, in addition to the simulation of air flows and temperature, it is additionally advantageous to simulate differences in the region of the perceptible thermal radiation which are not exclusively caused by a change in the air temperature. For this purpose, the solar simulation apparatus comprises a thermal radiation apparatus by means of which heat can be radiated into the interior space of the chamber and, in the process, towards the user from a radiation direction in the most targeted manner possible. This improves the perception of a simulation in accordance with which the user is moving around in a particularly sunny or shady area, or how close or far they are from a heat-radiating surface or from a hot or cold object.

It is also possible and optionally provided that the solar simulation apparatus comprises infrared radiators. By using infrared radiators as the thermal radiation apparatus, solar radiation acting on the user can be realistically simulated in terms of the irradiation location and the irradiation direction. In this case, the infrared radiators can be actuated and controlled independently of the simulation of the wind and the air conditioning. Depending on the virtual situation, one or more infrared radiators that are arranged at a distance from one another can be controlled depending on one another or independently of one another. This makes it possible to give the user of the simulation apparatus the feeling of a change in the radiation intensity while the air temperature remains the same.

Furthermore, it is optionally provided that the intensity of the solar radiation directed onto the user and/or an irradiation angle of the solar simulation apparatus can be modified. The intensity of the solar radiation simulated by the thermal radiation apparatus is directly dependent on the temperature perceived by the user. Therefore, it is advantageous to adjust the intensity of the thermal radiation apparatus in order to adjust the heat perceived by the user to the simulation as realistically as possible. In addition to simply controlling the intensity, it may be particularly advantageous to also be able to adjust the angle of incidence of the thermal radiation apparatus. As a result, on one hand the solar radiation can be simulated in an improved manner by an angle adjusted to reality and, on the other hand, it is possible, in particular in complex simulations, for fewer infrared radiators to have to be installed on the chamber, for example, since the orientation of these few infrared radiators can be adjusted.

Other advantageous configurations of the simulation chamber for simulating environmental and ambient conditions are explained with reference to exemplary embodiments shown in the drawings.

### BRIEF DESCRIPTION OF THE DRAWINGS

FIG. 1 is a schematic sectional view of a configuration of a simulation chamber with the air flow, air-conditioning flow and headwind flow being indicated,

FIG. 2 is a schematic sectional view of a simulation chamber comprising a positioning apparatus supporting a user,

FIG. 3 is a sectional view of a simulation chamber comprising a ball and an outflow opening for the headwind flow movably arranged on the side wall,

FIG. 4 is a plan view of the simulation chamber shown in FIG. 3,

FIG. 5 is a schematic sectional view of a simulation chamber comprising a robot arm and an outflow opening for the headwind flow fixed thereto,

FIG. 6 is a schematic sectional view of a horizontal sectional plane of a simulation chamber,

FIG. 7 is a schematic sectional view of a vertical sectional plane of the simulation chamber from FIG. 6 with the air flow from a flow-generating apparatus for simulating wind being indicated, and

FIG. 8 is a schematic sectional view of the simulation chamber from FIG. 6 with the air-conditioning flow from the air-conditioning unit for conditioning the ambient air being indicated.

### DETAILED DESCRIPTION

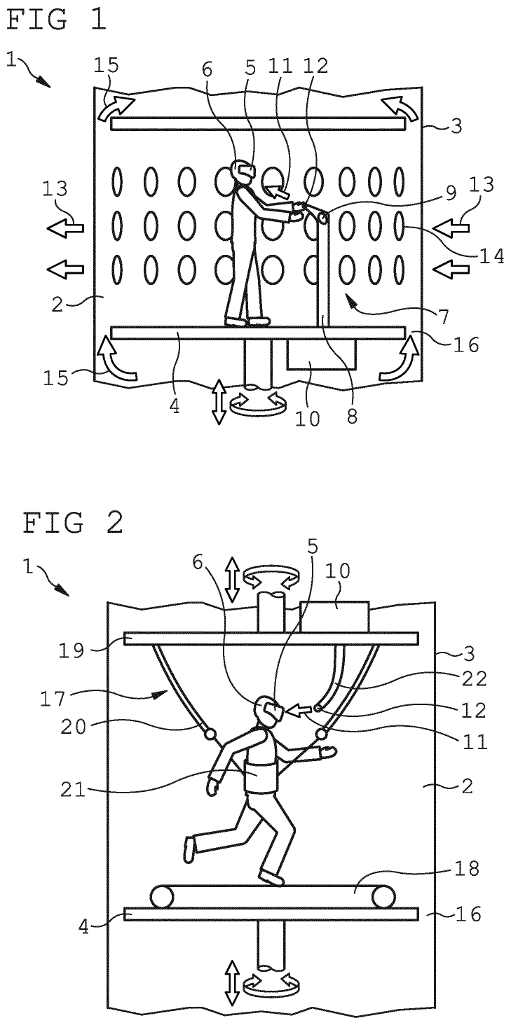

FIG. 1 is a schematic sectional view of an exemplary configuration of a simulation chamber 1. In this case, the simulation chamber 1 comprises a chamber 3 surrounding an interior space 2. A movement apparatus configured as a platform 4 which is configured so as to be rotatable about a vertical axis and movable along the vertical axis and on which the user 6 fitted with a virtual reality device 5 is located during the intended use of the simulation apparatus 1 is arranged on the floor of the simulation chamber 1.

The platform 4 comprises a holding device 7 for the user 6 to hold on to, comprising a cylindrical bar 8 that projects vertically from the floor and a handle 9 arranged horizontally at a right angle thereto. The handle 9 is configured such that the user 6 encloses the handle 9 with one hand or both hands during the simulation and holds on to it. A headwind flow-generating apparatus 10 for generating a headwind flow 11 is arranged underneath the platform 4. The headwind flow-generating apparatus 11 is connected to an outflow opening 12 arranged on the handle 9 via air channels (not shown in greater detail in the figure). The headwind flow 11 from the headwind flow-generating apparatus 10 can be directed towards the user 6 by means of the outflow opening 12 in order to thus simulate a headwind during a virtual movement. By arranging the headwind flow-generating apparatus 10 and the outflow opening 12 on the platform 4 and on the handle 9, respectively, the headwind flow 11 is always directed onto the user 6 head on even when the platform 4 rotates, in order for the headwind to be realistically experienced even when the user 6 is in motion.

The simulation chamber 1 further comprises a flow-generating apparatus, which is arranged outside the chamber 3 (and is not shown in greater detail in the figure) and is configured to conduct a generated air flow 13 into the interior space 2 of the chamber 3 through wind openings 14 for simulating ambient wind. In this case, the wind openings 14 are arranged at a distance from one another on the side walls of the chamber, such that an almost horizontal air flow 13 that is as laminar as possible through the chamber 3 can be achieved. This makes it possible to isolate both the simulation of ambient wind and the simulation of the headwind as far as possible in order to, on one hand, prevent any mutual influences and, on the other hand, to ensure that the headwind is always directed onto the user 6 head on from a predefined direction.

Furthermore, the simulation chamber 1 comprises an air-conditioning unit (not shown in greater detail), the air-conditioning unit being configured to adjust the air temperature and the humidity in the interior space 2 of the chamber 3 to the respective predefined values of the simulation in real time as far as possible by way of an air-conditioning flow 15 generated by the air-conditioning unit, the desired conditioned air being provided by the air-conditioning unit. For this purpose, air-conditioning openings 16 are arranged at an edge region of the floor between the platform 4 and the chamber 3. The air-conditioning openings 16 are used to introduce conditioned air from the air-conditioning unit into the interior space 2 via the air-conditioning openings 16 and to conduct it past the user 6 in a vertical direction towards the ceiling opposite the floor. By arranging the air-conditioning openings 16 at the edge region, the air-conditioning flow 15 can be guided past the user 6 and therefore does not cause any additional and undesired stimuli in the immediate surroundings of the user 6. The air-conditioning flow 15 is then conducted out of the interior space 2 again via the further air-conditioning openings 16 arranged on the ceiling.

FIG. 2 shows an alternative configuration of the simulation chamber 1 comprising a positioning apparatus 17. In this figure, in the same way as the configuration variant of the simulation chamber 1 in FIG. 1, the simulation chamber 1 comprises a platform 4 that is arranged on the floor and is configured to be rotatable and movable. Furthermore, and unlike the preceding figure, a treadmill 18 is arranged on a side of the platform 4 facing the user, which treadmill allows the user 6 to perform a running movement during the simulation substantially without leaving their position and therefore while remaining almost stationary. The positioning apparatus 17 is arranged on the ceiling of the chamber 3 and comprises a rotatable ring 19, which is mounted so as to be rotatable about an axis arranged in parallel with the vertical axis of the platform 4. The positioning apparatus 17 comprises two resilient ropes 20, which are fastened to a harness 21 worn by the user 6. The ropes 20 can thus support the user 6 during the simulation or during their movement and can thus protect them against injuries that can be caused by falling over. Furthermore, the headwind flow-generating apparatus 10 and an air duct 22 connected to the headwind flow-generating apparatus 10 comprising an outflow opening 12 directed towards the user is arranged on the rotatable ring 19. If the user turns around during the simulation about their vertical axis, the ring 19 of the positioning apparatus 17 and thus also the outflow opening 12 also turns with them, meaning that the headwind flow 11 is always directed onto the user 6 from a specific and predefined direction. In this exemplary embodiment, the air flow 13 and the air-conditioning flow 15 are not shown for the sake of clarity.

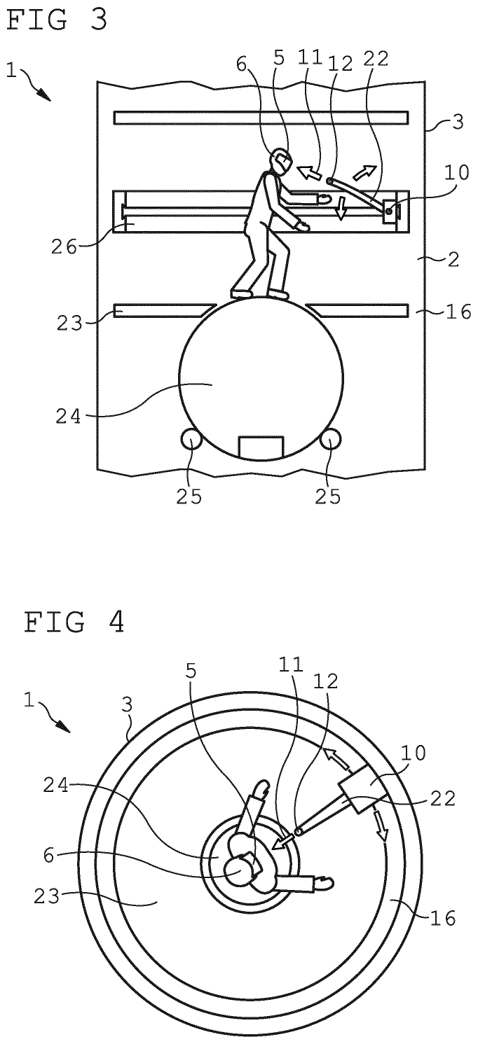

FIGS. 3 and 4 each show a further configuration variant of a simulation chamber. While FIG. 3 is a schematic sectional view of the simulation chamber 1, FIG. 4 is a plan view of the simulation chamber 1 from FIG. 3. In this configuration, the floor 23 comprises a centrally arranged cut-out, in which a rotatably mounted ball 24 is arranged such that the top of the ball 24 protrudes upwards through the cut-out. In order to mount the ball to be stationary and still rotatable, the ball 24 rests on cylindrical rollers 25 that are also rotatable. When the simulation chamber 1 is used, the user 6 stands on the ball 24, with the user 6 being able to move in any direction as desired while they remain almost stationary relative to the surrounding walls of the chamber 3. The movement apparatus in the form of a rail system 26 that is in parallel with the floor 23, is annular and comprises a rail and a slide is arranged on a side wall of the chamber 3. The headwind flow-generating apparatus 10 and the outflow opening 12 connected to the air duct 22 comprising the headwind flow-generating apparatus 10 is arranged on the slide. The outflow opening 12 can be moved along the annular rail 26 by means of the rail system 26. Furthermore, the air hose 22 and therefore the outflow opening 12 can be moved at an angle to a movement direction of the rail system 26.

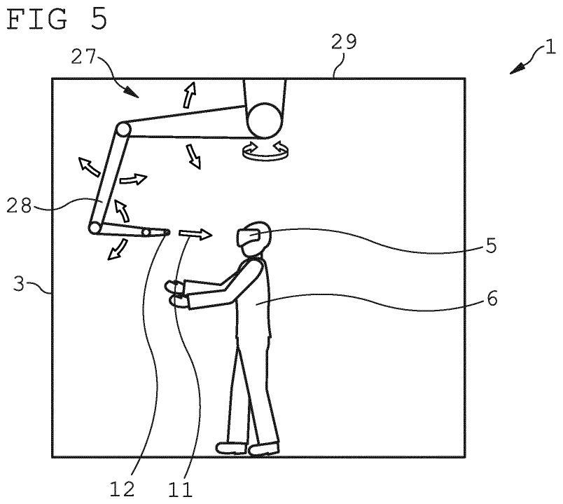

FIG. 5 shows the movement apparatus in the form of a robot arm 27 comprising a plurality of movable arm segments 28. The robot arm 27 is arranged on the ceiling 29 of the chamber 3 and comprises the outflow opening 12 at one end. By configuring the movement apparatus to be movable, the outflow opening 12 can be continually guided to follow a movement of the user 6 within the chamber 3 such that the headwind flow 11 flowing out through the outflow opening 12 is always directed onto the user 6 head on from a predefined direction.

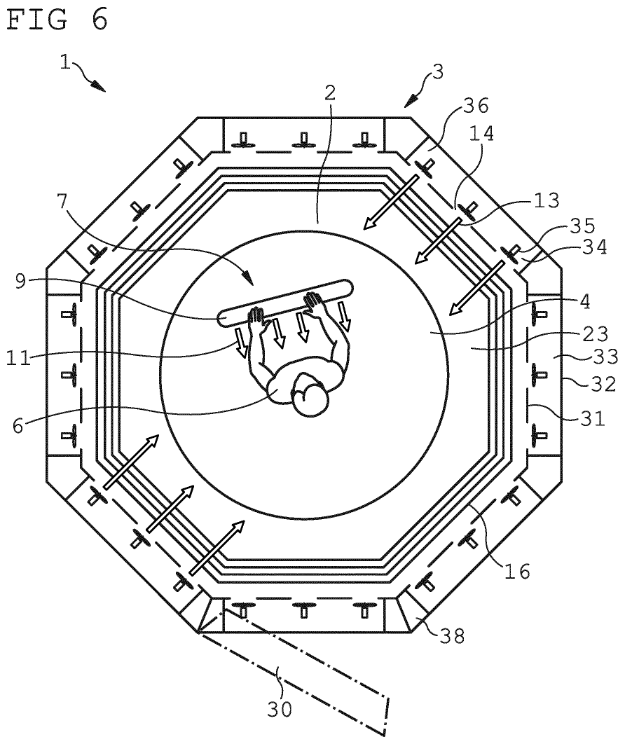

FIG. 6 to 8 are further schematic sectional views of a configuration of a simulation chamber 1, with the simulation chamber 1 being shown from different angles of view. In this case, the simulation chamber 1 comprises the chamber 3 surrounding the interior space 2, which chamber has an octagonal floor area. One of the eight side surfaces of the chamber 3 is configured as a door 30 in this case, the user 6 being able to enter the interior space 2 of the chamber 3 through the door 30. The entire chamber 3 is double-walled, with a surface 31 delimiting the interior space and a surface 32 delimiting the exterior space, which arranged at a distance therefrom. In this case, the surface 31 delimiting the interior space and the surface 32 delimiting the exterior space delimit an intermediate space 33 positioned therebetween. Here, the intermediate space 33 forms vertical shafts in a region of the side walls and forms one horizontal shaft each in a region of the floor 23 and of the ceiling 29.

The circular platform 4 that is mounted so as to be rotatable about a vertical axis is arranged on the floor 23 of the simulation chamber 1, which platform comprises the holding device 7 for the user 6 to hold on to. The holding device 11 comprises the cylindrical bar 8 that projects vertically from the floor and the handle 9 arranged horizontally at a right angle thereto. The handle 9 is configured such that the user 6 encloses the handle 9 with one hand or both hands during the simulation. The headwind flow-generating apparatus 10 (not shown in greater detail) for generating a headwind flow 11 is arranged on the holding device 7 and is configured to simulate a headwind during a virtual movement. By arranging the headwind flow-generating apparatus 10 on the platform 4, the headwind is always directed onto the user 6 head on even when the platform 4 rotates, in order for the headwind to be realistically experienced when the user 6 is in motion.

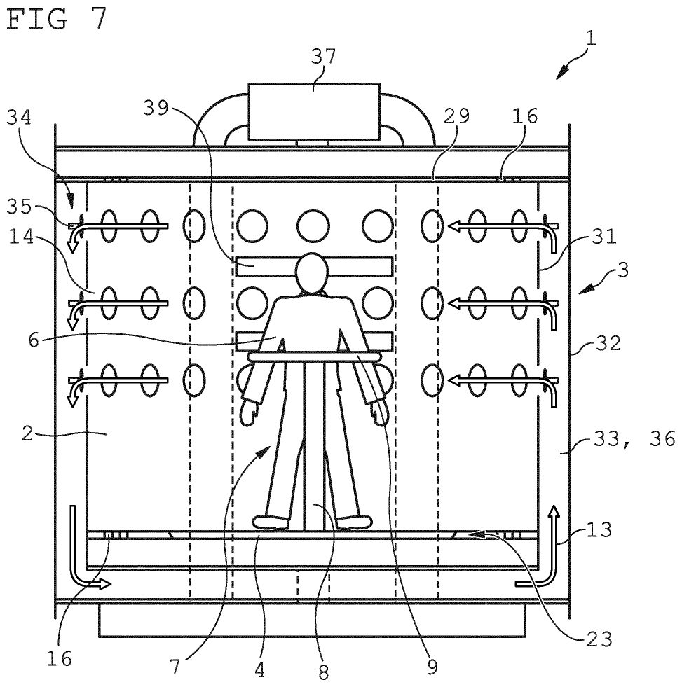

The simulation unit 1 also comprises the flow-generating apparatus 34 comprising a plurality of fans 35, which is provided and configured to simulate wind by means of the air flow 13 introduced into the interior space 2. For this purpose, a plurality of fans 35 arranged at a distance from one another are arranged in the intermediate space 33. The air flow 13 which can be introduced into the interior space 2 through the wind openings 14 arranged on the side walls can be generated by actuating individual fans 35 in a targeted manner. By means of an assigned wind opening 14 on an outlet side opposite the inlet side, a largely laminar and horizontally guided air flow 13 from the inlet side to the outlet side can be achieved, by means of which a wind prevailing in the simulated environment is simulated and is generated in the chamber 3 by means of the corresponding air flow 13. The air flow 13 carried away from the chamber 3 on the outlet side is conducted into a wind shaft 36 in the intermediate space 35 between the surface 31 delimiting the interior space and the surface 32 delimiting the exterior space and can be supplied to the wind circuit again. The path of the air flow 13 generated by the flow-generating apparatus 34 is shown in FIG. 7 on the basis of a vertical sectional view.

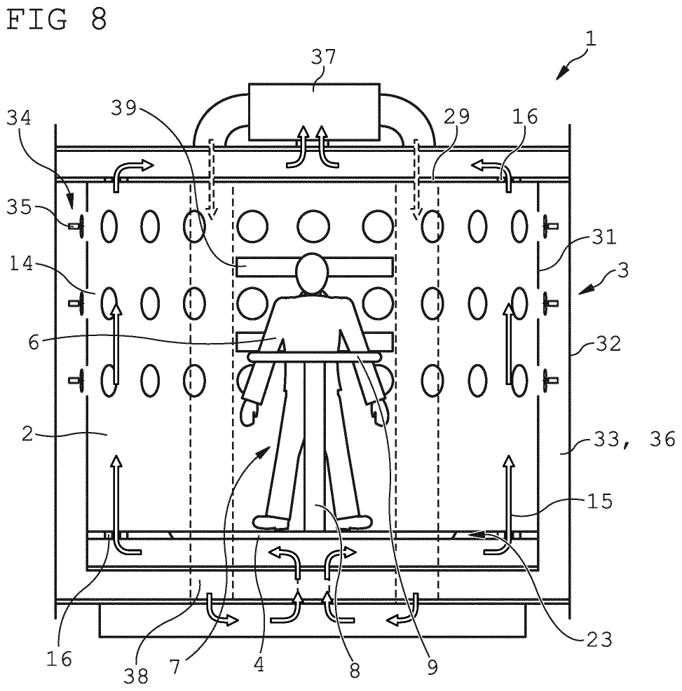

Furthermore, the simulation chamber 1 comprises the air-conditioning unit 37, the air-conditioning unit 37 being configured to adjust the air temperature and the humidity in the interior space 2 of the chamber 3 to the respective predefined values of the simulation in real time as far as possible by way of the air-conditioning flow 15 generated by the air-conditioning unit 37, the desired conditioned air being provided by the air-conditioning unit 37. For this purpose, a plurality of air-conditioning openings 16 arranged at a distance from one another are arranged at the edge region of the floor 23. In this case, the air-conditioning openings 16 are implemented as slots penetrating the floor 23. The air-conditioning openings 16 are used to introduce conditioned air from the air-conditioning unit 37 into the interior space 2 via the air-conditioning openings 16 and to conduct it past the user 6 in a vertical direction towards the ceiling 29 opposite the floor 23. By arranging the air-conditioning openings 16 at the edge region, the air-conditioning flow 15 can be guided past the user 6 and therefore does not cause any additional and undesired stimuli in the immediate surroundings of the user 6. The air-conditioning flow 15 is then conducted out of the interior space 2 again into the intermediate space 33 or into an air-conditioning shaft 38 between the he surface 31 delimiting the interior space and the surface 32 delimiting the exterior space via the further air-conditioning openings 16 arranged on the ceiling 29. The air-conditioning shaft 38 is spatially separate from the wind shaft 36 here. In this case, the air-conditioning unit 37 and the air-conditioning openings 16 arranged on the floor 23 and the ceiling 29 form a closed air-conditioning circuit, which is only open in the region of the interior space 2 of the chamber 3. The path of the air movements of the air-conditioning unit 37 is shown in FIG. 8 on the basis of a sectional view.

Furthermore, the simulation chamber 1 comprises a thermal radiation apparatus which is configured as a plurality of infrared radiators 39 and is configured to simulate precisely positioned solar radiation or irradiation of warm surfaces by thermal radiation being directed onto the user 6 by the infrared radiators 39 or onto a surface to be heated within the chamber 3.

### LIST OF REFERENCE SIGNS

1 Simulation chamber
2 Interior space
3 Chamber
4 Platform
5 Virtual reality device
6 User
7 Holding device
8 Cylindrical bar of the holding device
9 Handle of the holding device
10 Headwind flow-generating apparatus
11 Headwind flow
12 Outflow opening
13 Air flow
14 Wind opening
15 Air-conditioning flow
16 Air-conditioning openings
17 Positioning apparatus
18 Treadmill
19 Ring
20 Ropes
21 Harness
22 Air duct
23 Floor
24 Ball
25 Roller
26 Rail
27 Robot arm
28 Arm segments
29 Ceiling
30 Doors
31 Surface delimiting the interior space
32 Surface delimiting the exterior space
33 Intermediate space
34 Flow-generating apparatus
35 Fan
36 Wind shaft
37 Air-conditioning unit
38 Air-conditioning shaft
39 Infrared radiator

1.-23. (canceled)

24. A simulation chamber (1) for use by a user (6) with a virtual reality device (5) for visually simulating environmental and ambient conditions, wherein the simulation chamber (1) comprises:
a chamber (3) surrounding an interior space (2);
a flow-generating apparatus (34) arranged on the chamber (3) for generating an air flow (13) in the interior space (2);
a headwind flow-generating apparatus (10) having at least one outflow opening (12), the at least one outflow opening being arranged in the chamber (3) so as to be movable by a movement apparatus,
wherein the at least one outflow opening (12) can be moved by the movement apparatus such that a headwind flow (11) can be directed, through the at least one outflow opening (12), onto the user (6) located in the interior space (2) of the chamber (3) during intended use such that the headwind flow (11) flows against the user (6) from a consistently predefinable headwind flow direction relative to an orientation of the user (6).

25. The simulation chamber according to claim 24,
wherein the movement apparatus is a platform (4) which is mounted so as to be rotatable about a vertical axis on a floor (23) of the interior space (2) of the chamber (3) and on which the user (6) fitted with the virtual reality device (5) is located during the intended use, and
wherein the at least one outflow opening (12) is arranged on the platform (4).

26. The simulation chamber (1) according to claim 25,
wherein the platform (4) comprises a holding device (7) such that the user (6) standing on the platform (4) can hold on to the holding device (7) with at least one hand.

27. The simulation chamber (1) according to claim 26,
wherein the at least one outflow opening (12) is arranged on the holding device (7).

28. The simulation chamber (1) according to claim 24,
wherein the simulation chamber (1) comprises a positioning apparatus (17) arranged in the chamber (3), which is configured to support the user (6) in the chamber (3) in order to facilitate movements on a spot.

29. The simulation chamber (1) according to claim 28,
wherein the positioning apparatus (17) and/or the movement apparatus comprises a first arm segment and at least one second arm segment arranged thereon, wherein the first arm segment and the at least one second arm segment are movable relative to one another.

30. The simulation chamber (1) according to claim 24,
wherein the simulation chamber (1) comprises a position detection apparatus,
wherein a position and the orientation of the user (6) are detected by the position detection apparatus, and
wherein the at least one outflow opening (12) can be guided to follow the user (6) such that the headwind flow (11) is always directed onto the user (6) from a predefined direction.

31. The simulation chamber (1) according to claim 26,
wherein the platform (4) comprises a treadmill (18), such that the treadmill (18) can be used to simulate the user (6) running.

32. The simulation chamber (1) according to claim 31,
wherein the platform (4) comprises a seat.

33. The simulation chamber (1) according to claim 32,
wherein the headwind flow-generating apparatus (10) or the at least one outflow opening (12) is arranged on the seat.

34. The simulation chamber (1) according to claim 32,
wherein the holding device (7) and/or the treadmill (18) and/or the seat are arranged to be pivotable at an angle to the vertical axis.

35. The simulation chamber (1) according to claim 24,
wherein the flow-generating apparatus (34) is configured to simulate ambient wind in the interior space (2) of the chamber (3) by the air flow (13).

36. The simulation chamber (1) according to claim 24,
wherein the simulation chamber (1) comprises an air-conditioning unit (37) for regulating temperature and/or humidity in the interior space (2).

37. The simulation chamber (1) according to claim 36,
wherein the air-conditioning unit (37) is configured to introduce air conditioned by means of a generated air-conditioning flow (15) into the interior space (2).

38. The simulation chamber (1) according to claim 36,
wherein the chamber (3) is configured to be double-walled, with a surface (31) delimiting the interior space and a further surface (32) delimiting an exterior space that is arranged at a distance from the surface (31) delimiting the interior space, and
wherein the surface (31) delimiting the interior space comprises openable through-flow openings for admitting air into the interior space (2) or letting it out of the interior space (2).

39. The simulation chamber (1) according to claim 38,
wherein the flow-generating apparatus (34) and/or the air-conditioning unit (37) are arranged in an intermediate space (33) between the surface (31) delimiting the interior space and the further surface (32) delimiting the exterior space.

40. The simulation chamber (1) according to claim 38,
wherein the openable through-flow openings are configured such that conditioned air from the air-conditioning unit (37) and/or the air flow (13) from the flow-generating apparatus (34) can be conducted into the interior space (2) and/or out of the interior space (2).

41. The simulation chamber (1) according to claim 37,
wherein air conditioned by the air-conditioning unit (37) is conducted into the interior space (2) through at least one air-conditioning opening (16) arranged on a floor (23) and is conducted out of the interior space (2) through at least one further air-conditioning opening (16) on a ceiling (29) opposite the floor (23).

42. The simulation chamber (1) according to claim 41,
wherein the air flow (13) generated by the flow-generating apparatus (34) is a laminar flow, which is conducted into the interior space (2) through at least one wind opening (14) arranged on a side wall of the chamber (3) and is conducted out of the interior space (2) through at least one further wind opening (14) arranged on an opposite side wall.

43. The simulation chamber (1) according to claim 42,
wherein the at least one air-conditioning opening (16) in the floor (23) or close to the floor and the at least one wind opening (14) on the side wall are arranged to be laterally offset, such that turbulence of the air flow (13) and the generated air-conditioning flow (15) can be avoided.

44. The simulation chamber (1) according to claim 24,
wherein the simulation chamber (1) comprises a solar simulation apparatus for simulating solar radiation.

45. The simulation chamber (1) according to claim 44,
wherein the solar simulation apparatus comprises at least one infrared radiator (39).

46. The simulation chamber (1) according to claim 44,
wherein an intensity of the solar radiation directed onto the user (6) and/or an irradiation angle of the solar simulation apparatus can be modified.
